(19) United States
(12) Patent Application Publication
(10) Pub. No.: US 2024/0340349 A1
(43) Pub. Date: Oct. 10, 2024

(54) WIRELESS COMMUNICATION APPARATUS AND WIRELESS COMMUNICATION METHOD

(71) Applicant: DENSO CORPORATION, Kariya-city (JP)

(72) Inventor: Fumihide GOTO, Kariya-city (JP)

(21) Appl. No.: 18/607,438

(22) Filed: Mar. 16, 2024

(30) Foreign Application Priority Data
Apr. 5, 2023 (JP) 2023-061370

(51) Int. Cl. H04L 67/146; H04L 67/56; H04W 76/19; H04W 84/12

(52) U.S. Cl. CPC H04L 67/146; H04L 67/56; H04W 76/19; H04W 84/12

(57) ABSTRACT

An SBP initiator includes a controller and a communicator. The controller and the communicator are configured to establish an SBP session by exchanging, with an SBP responder, a first wireless frame for establishing the SBP session. In a case where the SBP session is disconnected, the controller and the communicator are configured to reestablish the SBP session by exchanging, with the SBP responder, a second wireless frame for establishing the SBP session.

### CROSS-REFERENCE TO RELATED APPLICATION

The present application is based on and claims the benefit of priority to Japanese Patent Application No. 2023-061370 filed on Apr. 5, 2023, the contents of which are incorporated herein by reference in its entirety.

### BACKGROUND

### Technical Field

The present disclosure relates to a wireless communication apparatus and a wireless communication method.

### Background

In the IEEE 802.11 working group regarding the wireless local area network (wireless LAN (WLAN)) standards, a new task group regarding IEEE 802.11bf has been established. In IEEE 802.11bf, standard specifications related to WLAN sensing have been drafted.

WLAN sensing is a technology for estimating presence, positions, and the like of humans, based on propagation characteristics of signals between antennas of apparatuses that perform WLAN communication. WLAN sensing is implemented mainly by a wireless communication system including an access point (AP) and a station (STA).

Regarding WLAN sensing, some methods are defined. As one of the methods, a sensing by proxy (SBP) procedure is defined. In WLAN sensing, roles for executing WLAN sensing are defined, examples of which include a sensing initiator that initiates sensing and a sensing responder that responds to a request from the sensing initiator. In the SBP procedure, a certain STA has a role of an SBP initiator, and an AP has a role of an SBP responder.

In the SBP procedure, an SBP session is established between the STA as the SBP initiator and the AP as the SBP responder. When the SBP session is established, the AP executes as the sensing initiator the sensing procedure with another STA as the sensing responder, and finally transmits an SBP report to the STA as the SBP initiator.

### SUMMARY

The present disclosure provides a sensing by proxy (SBP) initiator. The SBP initiator establishes an SBP session by exchanging, with an SBP responder, a first wireless frame for establishing the SBP session. In a case where the SBP session is disconnected, the SBP initiator reestablishes the SBP session by exchanging, with the SBP responder, a second wireless frame for establishing the SBP session.

The present disclosure provides a sensing by proxy (SBP) responder. The SBP responder establishes an SBP session by exchanging, with an SBP initiator, a first wireless frame for establishing the SBP session. In a case where the SBP session is disconnected, the SBP responder reestablishes the SBP session by exchanging, with the SBP initiator, a second wireless frame for establishing the SBP session.

### BRIEF DESCRIPTION OF THE DRAWINGS

The above and other objects, features, and advantages of the present disclosure will become more apparent in the following detailed description with reference to the accompanying drawings, in which:

FIG. 1 is a block diagram illustrating an example of a configuration of a wireless communication system;

FIG. 2 is a block diagram illustrating an example of another configuration of the wireless communication system;

FIG. 3 is a block diagram illustrating an example of yet another configuration of the wireless communication system;

FIG. 4 is a block diagram illustrating an example of a hardware configuration of an STA;

FIG. 5 is a block diagram illustrating an example of a functional configuration of the STA;

FIG. 6 is a block diagram illustrating an example of a hardware configuration of an AP;

FIG. 7 is a block diagram illustrating an example of a functional configuration of the AP;

FIG. 8 is a diagram illustrating an SBP procedure according to prior art;

FIG. 9 is a diagram illustrating a sensing procedure according to prior art;

FIG. 10 is a diagram illustrating an example of processing for reestablishing an SBP session according to a first embodiment;

FIG. 11 is a diagram illustrating another example of processing for reestablishing an SBP session according to the first embodiment;

FIG. 12 is a diagram illustrating an example of processing for reestablishing an SBP session according to a second embodiment; and

FIG. 13 is a diagram illustrating another example of processing for reestablishing an SBP session according to the second embodiment.

### DETAILED DESCRIPTION

Hereinafter, embodiments of the present disclosure will be described in detail with reference to the accompanying drawings. Note that, in the Specification and drawings, elements to which similar descriptions are applicable are denoted by the same reference signs, and overlapping descriptions may hence be omitted.

Each embodiment described below is merely an example of a configuration that can implement the present disclosure. Each embodiment described below can be appropriately modified or changed according to a configuration of an apparatus to which the present disclosure is applied and various conditions. All of combinations of elements included in each embodiment described below are not necessarily required to implement the present disclosure, and a part of the elements can be appropriately omitted. Hence, the scope of the present disclosure is not limited by the configuration described in each embodiment described below. Configurations in which a plurality of configurations described in the embodiments below are combined can also be employed unless the configurations are consistent with each other.

For example, when a failure occurs in communication between an SBP initiator and an SBP responder after an SBP session is established and before the SBP initiator receives an SBP report, the SBP session is disconnected. In such a state, the SBP initiator cannot receive the SBP report. In the current IEEE 802.11bf, there is no definition as to resumption of an SBP procedure after the SBP session is disconnected. The present disclosure provides a technique for resuming the SBP procedure after the SBP session is disconnected in the SBP procedure for executing WLAN sensing.

In the embodiments to be described below, the SBP initiator and the SBP responder establish an SBP session. The SBP session is established by exchanging a first wireless frame for establishing the SBP session between the SBP initiator and the SBP responder. Subsequently, in a case where the SBP session is disconnected, the SBP initiator and the SBP responder establish the SBP session again. The SBP session is established by exchanging a second wireless frame for establishing the SBP session between the SBP initiator and the SBP responder. In this manner, in a case where the SBP session is disconnected, the SBP initiator and the SBP responder resume the SBP procedure.

### 1. Radio Communication System

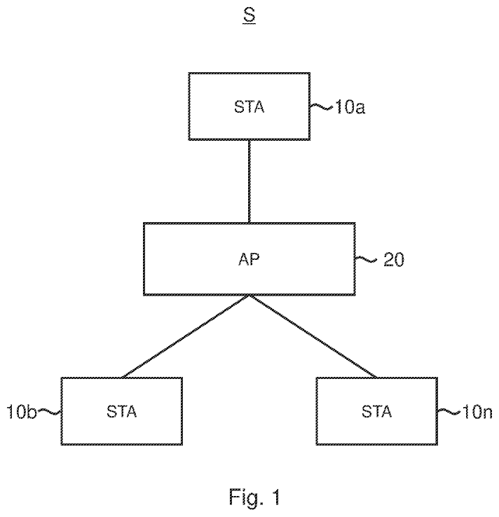

As illustrated in FIG. 1, a wireless communication system S according to the present embodiment includes two or more stations (STAs) 10a, 10b, and 10n and at least one access point (AP) 20. The wireless communication system S is configured to execute a WLAN sensing procedure employing the SBP procedure, in accordance with IEEE 802.11bf. When the STAs 10a, 10b, and 10n are not distinguished from each other, the STAs 10a, 10b, and 10n are hereinafter collectively referred to as a “STA(s) 10”. The STA 10 and the AP 20 may both be referred to as a wireless communication apparatus or a “node”.

The STA 10 is a wireless communication apparatus that performs wireless communication with the AP 20 in accordance with the IEEE 802.11 standard. Any STA 10 among the STAs 10 requests the AP 20 to initiate the SBP procedure for executing the WLAN sensing procedure. The wireless communication apparatus or the node that requests initiation of the SBP procedure is hereinafter referred to as an “SBP initiator”, an “SBP initiator node”, or a “wireless communication apparatus functioning as the SBP initiator”. In the present embodiment, the STA 10a has a role of the SBP initiator.

Any STA 10 among the STAs 10 executes the WLAN sensing procedure with the AP 20, in response to the request to execute the WLAN sensing procedure. The wireless communication apparatus or the node that executes WLAN sensing in response to the request to execute WLAN sensing is hereinafter referred to as a “sensing responder”, a “sensing responder node”, or a “wireless communication apparatus functioning as the sensing responder”. In the present embodiment, the STA 10b and the STA 10n each have a role of the sensing responder.

The AP 20 is a wireless communication apparatus that performs wireless communication with the STA 10 located within a reachable range of radio waves of the AP 20. The AP 20 has a base station function for connecting the STA 10 to a network. In general, the STA 10 may also have a role of the AP 20 and the AP 20 may have a role of the STA 10, but in the present embodiment, the wireless communication apparatus or the node not having the base station function is referred to as an STA, and the wireless communication apparatus or the node having the base station function is referred to as an AP.

Note that, in the IEEE 802.11 standard, a network configuration including the AP 20 and the STA 10 is referred to as an infrastructure mode. In the infrastructure mode, the network configuration including the AP and the STA 10 communicating with the AP 20 is referred to as a basic service set (BSS). The AP 20 may communicate with another AP 20 belonging to another BSS.

The AP 20 establishes an SBP session with the SBP initiator in response to a request from the SBP initiator. The SBP session is established by exchanging a wireless frame with the SBP initiator. The wireless communication apparatus or the node that establishes the SBP session with the SBP initiator in response to the request from the SBP initiator is hereinafter referred to as an “SBP responder”, an “SBP responder node”, or a “wireless communication apparatus functioning as the SBP responder”. In the present embodiment, the AP 20 has a role of the SBP responder.

In response to the request from the SBP initiator, the AP 20 requests the sensing responder to execute the WLAN sensing procedure. The wireless communication apparatus or the node that requests the sensing responder to execute the WLAN sensing procedure is hereinafter referred to as a “sensing initiator”, a “sensing initiator node”, or a “wireless communication apparatus functioning as the sensing initiator”. In the present embodiment, the AP 20 also has a role of the sensing initiator as well as the SBP responder.

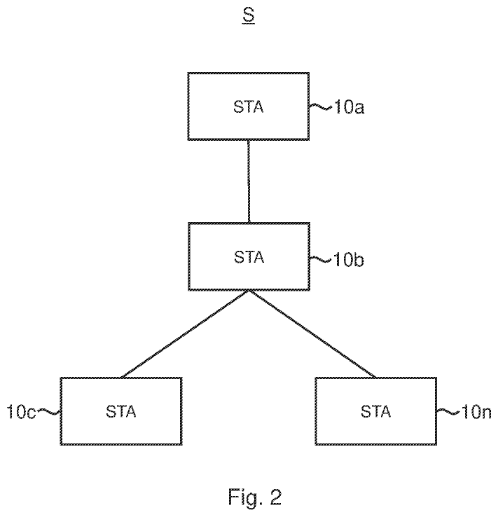

As described above, the wireless communication system S according to the present embodiment employs the network configuration of the infrastructure mode, but is not limited to such a configuration. For example, as illustrated in FIG. 2, the wireless communication system S may employ a network configuration including only the STAs 10, without including the AP 20. In the IEEE 802.11 standard, the network configuration including only the STAs 10 is referred to as an ad hoc mode. In the ad hoc mode, the network configuration including only the STAs 10 is referred to as an independent basic service set (independent BSS (IBSS)).

When the wireless communication system S employs the network configuration of the ad hoc mode, for example, the STA 10a illustrated in FIG. 2 may have a role of the SBP initiator. The STA 10b may have roles of the SBP responder and the sensing initiator. Furthermore, STAs 10c and 10n may each have a role of the sensing responder.

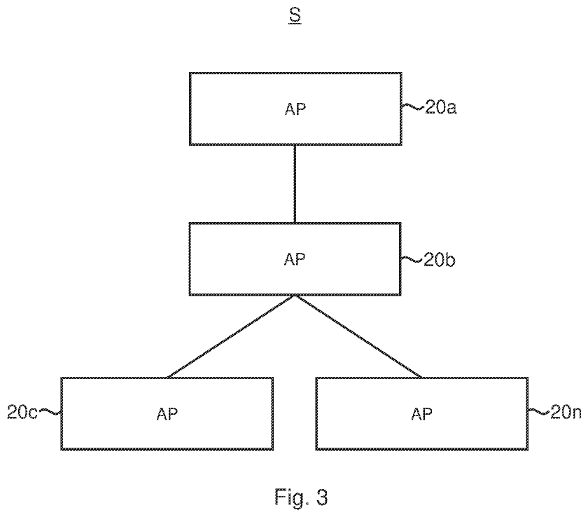

In addition to the above, for example, as illustrated in FIG. 3, the wireless communication system S may employ a network configuration including only the APs 20, without including the STA 10. In the IEEE 802.11 standard, the network configuration including only the APs 20 is referred to as a wireless distribution system (WDS).

When the wireless communication system S employs the network configuration of WDS, an AP 20a illustrated in FIG. 3 may have a role of the SBP initiator, for example. An AP 20b may have roles of the SBP responder and the sensing initiator. Furthermore, APs 20b and 20n may each have a role of the sensing responder. Note that the AP 20b may have functions of both of the STA 10 and the AP 20.

Although the SBP initiator is a node independent of the sensing responder in the above description, such a configuration need not necessarily be employed. The SBP initiator may be the same node as the sensing responder. In this case, when the STA 10a illustrated in FIG. 1 has functions of both of the SBP initiator and the sensing responder, the STA 10a requests the AP 20 as the SBP responder to initiate the SBP session, responds to the request from the AP 20 as the sensing initiator, and thereby executes the sensing procedure with the AP 20.

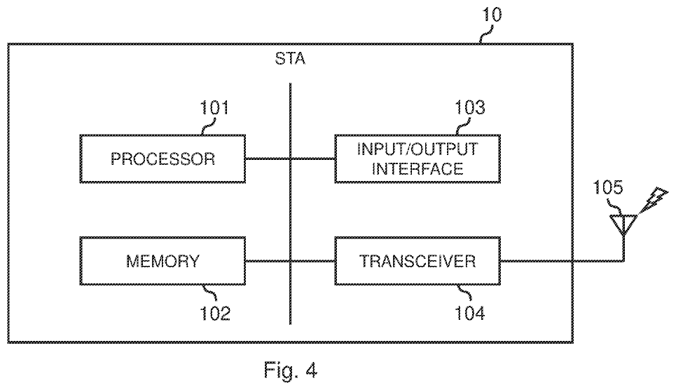

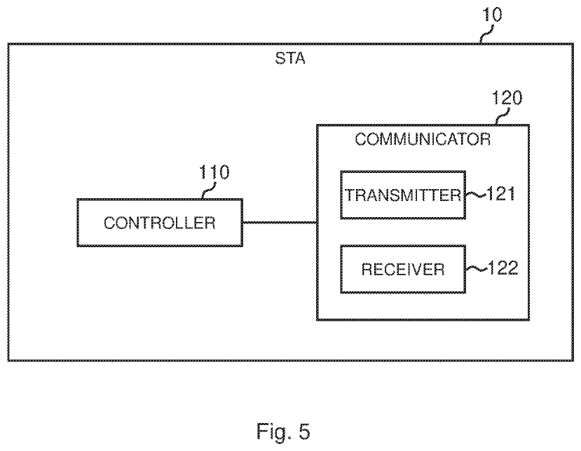

Next, with reference to FIG. 4 and FIG. 5, a configuration of the STA 10 will be described. As illustrated in FIG. 4, the STA 10 includes, as hardware elements, one or more processors (hereinafter, simply referred to as a processor) 101, a memory 102, an input/output interface 103, a transceiver 104, and an antenna 105. The above elements provided in the STA 10 are connected to each other via an internal bus. Note that the STA 10 may include a hardware element other than the elements illustrated in FIG. 4. The processor 101 is an arithmetic element that implements various functions of the STA 10. The processor 101 may be a central processing unit (CPU), a graphics processing unit (GPU), and a system-on-a-chip (SoC) including an element such as a memory controller.

The memory 102 includes a storage medium, such as a random access memory (RAM) and an embedded multi media card (eMMC). The memory 102 is an element that temporarily or permanently stores a program and data used to execute various types of processing in the STA 10. The program includes one or more instructions for operations of the STA 10. The processor 101 deploys the program stored in the memory 102, into the memory 102 and/or a system memory (not illustrated) and executes the program, to thereby implement the functions of the STA 10.

The input/output interface 103 is an interface that receives an operation to the STA 10 and supplies the operation to the processor 101, and presents various pieces of information to a user. The input/output interface 103 may include a touch panel, for example.

The transceiver 104 includes a transmitting device and a receiving device (not illustrated), is a circuit that executes various types of signal processing for implementing wireless communication, and includes a baseband processor and an RF circuit. The transceiver 104 exchanges a wireless signal with the AP 20 via the antenna 105.

As illustrated in FIG. 5, the STA 10 includes, as functional blocks, a controller 110 and a communicator 120. The communicator 120 includes a transmitter 121 and a receiver 122.

The controller 110 includes the processor 101 and the memory 102. In other words, the controller 110 is implemented by the processor 101 and the memory 102. The controller 110 executes various types of control processing in the STA 10. For example, the controller 110 controls wireless communication with the AP 20 via the communicator 120. When the controller 110 operates, the various types of processing of the STA 10 of the present embodiment are executed.

The communicator 120 includes the transceiver 104 and the antenna 105. In other words, the communicator 120 is implemented by the transceiver 104 and the antenna 105. The communicator 120 exchanges a wireless signal with the AP 20, and thereby performs wireless communication with the AP 20.

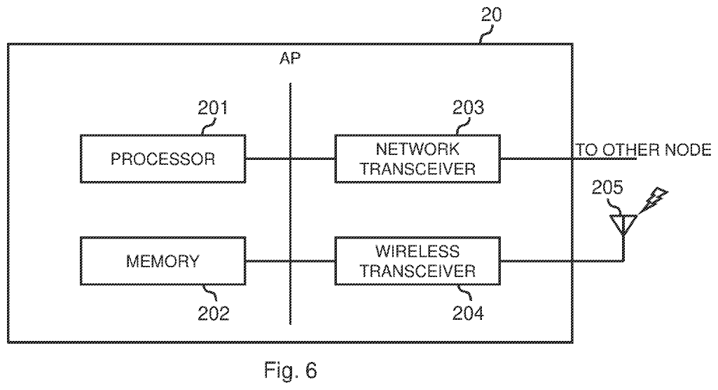

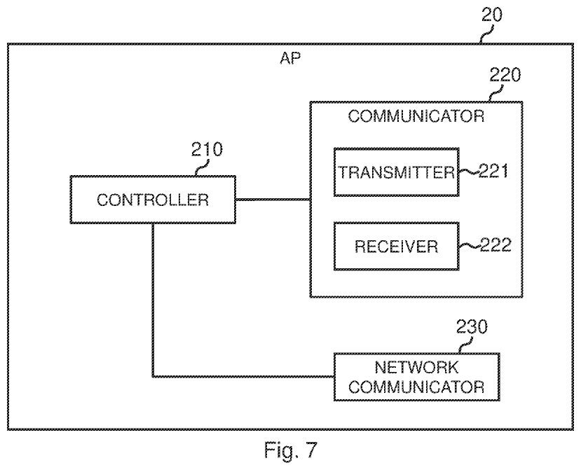

Next, with reference to FIG. 6 and FIG. 7, a configuration of the AP 20 will be described. As illustrated in FIG. 6, the AP 20 includes, as hardware elements, one or more processors (hereinafter, simply referred to as a processor) 201, a memory 202, a network transceiver 203, a wireless transceiver 204, and an antenna 205. The above elements provided in the AP 20 are connected to each other via an internal bus. Note that the AP 20 may include a hardware element other than the elements illustrated in FIG. 6.

The processor 201 is an arithmetic element that implements various functions of the AP 20. The processor 201 may be a CPU, and may further include another processor such as a GPU.

The memory 202 includes a storage medium, such as a read only memory (ROM), a RAM, a hard disk drive (HDD), and a solid state drive (SSD). The memory 202 is an element that temporarily or permanently stores a program and data used to execute various types of processing in the AP 20. The program includes one or more instructions for operations of the AP 20. The processor 201 deploys the program stored in the memory 202, into the memory 202 and/or a system memory (not illustrated) and executes the program, to thereby implement the functions of the AP 20.

The network transceiver 203 exchanges a signal with another AP 20. Such another AP 20 is, for example, an AP 20 located outside within a reachable range of radio waves of the AP 20, in other words, an AP 20 belonging to another BSS.

The wireless transceiver 204 includes a transmitting device and a receiving device (not illustrated), is a circuit that executes various types of signal processing for implementing wireless communication, and includes a baseband processor and an RF circuit. The wireless transceiver 204 exchanges a wireless signal with the STA 10 via the antenna 205.

As illustrated in FIG. 7, the AP 20 includes, as functional blocks, a controller 210, a communicator 220, and a network communicator 230. The communicator 220 includes a transmitter 221 and a receiver 222.

The controller 210 includes the processor 201 and the memory 202. In other words, the controller 210 is implemented by the processor 201 and the memory 202. The controller 210 executes various types of control processing in the AP 20. For example, the controller 210 controls wireless communication with the STA 10 via the communicator 220. For example, the controller 210 controls communication with another node (for example, a node such as another AP 20) via the network communicator 230. When the controller 210 operates, the various types of processing of the AP 20 of the present embodiment are executed.

The communicator 220 includes the wireless transceiver 204 and the antenna 205. In other words, the communicator 220 is implemented by the wireless transceiver 204 and the antenna 205. The communicator 220 exchanges a wireless signal with the STA 10, and thereby performs wireless communication with the STA 10.

The network communicator 230 includes the network transceiver 203. In other words, the network communicator 230 is implemented by the network transceiver 203. The network transceiver 203 exchanges a signal with a network (or another node described above).

### 2. SBP Procedure

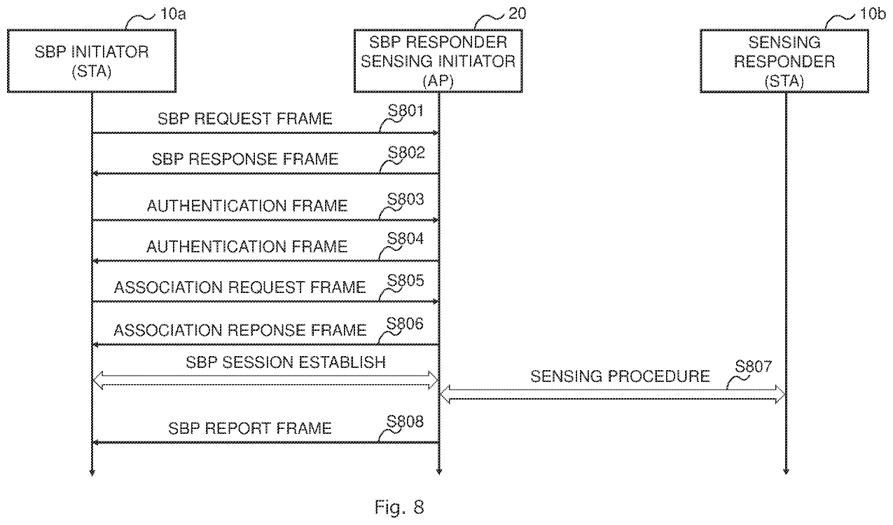

Next, with reference to FIG. 8, the SBP procedure according to prior art will be described. IEEE 802.11bf defines a trigger based (TB) sensing measurement instance (TB Sensing measurement instance) as another method of the WLAN sensing procedure. In the TB sensing measurement instance, a request from the sensing initiator is a trigger for initiation of the sensing procedure. In other words, in response to the request from the sensing initiator, the sensing procedure is executed between the sensing initiator and the sensing responder.

In the SBP procedure, the SBP responder also has a role of the sensing initiator, and the SBP initiator requests the SBP responder to initiate the sensing procedure on behalf of the sensing initiator. In response to the request from the SBP initiator, an SBP session is established between the SBP initiator and the SBP responder. When the SBP session is established, in response to the request from the sensing initiator, the sensing procedure based on the TB sensing measurement instance is executed between the sensing initiator and the sensing responder.

In description of FIG. 8, a case is assumed that the STA 10a described with reference to FIG. 1 has a role of the SBP initiator. The AP 20 described with reference to FIG. 1 has roles of the SBP responder and the sensing initiator. Furthermore, the STA 10b described with reference to FIG. 1 has a role of the sensing responder. Note that a plurality of sensing responders may be present for one sensing initiator, and in this case, the sensing initiator executes the sensing procedure with each of the sensing responders.

The SBP procedure is executed by exchanging a wireless frame between the STA 10a, the STA 10b, and the AP 20. The wireless frame may be referred to as a wireless signal. The wireless frame includes a media access control (MAC) frame exchanged on a MAC layer. The MAC frame is defined in the IEEE 802.11 standard.

The IEEE 802.11 standard defines three types of wireless frames: a management frame, a control frame, and a data frame. The management frame is used to execute authentication, association, and the like used in the SBP procedure. The control frame is used to transmit a confirmation response (ACK) frame or the like. The data frame is used to transmit user data.

In the SBP procedure, the management frame is used. The management frame includes fields, such as a frame control field, a destination address, a transmission source address, and a BSSID. The frame control field includes a type field and a sub-type field. In the type field, a value indicating one of the management frame, the control frame, and the data frame described above is configured. In the sub-type field, a value indicating a sub-type of a wireless frame, such as an authentication frame or an association request frame, to be described below is configured.

In the destination address, an identifier, in other words, a device ID, for identifying a node as a transmission destination of the wireless frame is configured. The device ID includes a MAC address. In the transmission source address, an identifier, in other words, a device ID, for identifying a node as a transmission source of the wireless frame is configured. The device ID includes a MAC address. In the BSSID, an ID for identifying a BSS is configured, and usually, a MAC address of the AP 20 belonging to a target BSS is configured.

In Step S801, the controller 110 in the SBP initiator generates an SBP request frame, and the transmitter 121 of the communicator 120 transmits the SBP request frame to the SBP responder. The SBP request frame is generated by configuring a value indicating the management frame to the type field described above, and configuring a value indicating the SBP request frame to the sub-type field. The SBP request frame may be referred to as an SBP request signal.

Next, the controller 210 in the SBP responder generates an SBP response frame, and the transmitter 221 of the communicator 220 transmits the SBP response frame to the SBP initiator (Step S802). The SBP response frame is generated by configuring a value indicating the management frame to the type field described above, and configuring a value indicating the SBP response frame to the sub-type field. The SBP response frame may be referred to as an SBP response signal.

Next, the controller 110 in the SBP initiator generates an authentication frame, and the transmitter 121 transmits the authentication frame to the SBP responder (Step S803). The authentication frame is generated by configuring a value indicating the management frame to the type field described above, and configuring a value indicating the authentication frame to the sub-type field. The authentication frame may be referred to as an authentication signal. Similarly, the SBP responder also transmits the authentication frame to the SBP initiator as described above (Step S804). Through the processing of Step S803 and Step S804, mutual authentication is executed.

Next, the controller 110 in the SBP initiator generates an association request frame, and the transmitter 121 transmits the association request frame to the SBP responder (Step S805). The association request frame is generated by configuring a value indicating the management frame to the type field described above, and configuring a value indicating the association request frame to the sub-type field. The association request frame may be referred to as an association request signal.

Next, the controller 210 in the SBP responder generates an association response frame, and the transmitter 221 transmits the association response frame to the SBP initiator (Step S806). The association response frame is generated by configuring a value indicating the management frame to the type field described above, and configuring a value indicating the association response frame to the sub-type field. The association response frame may be referred to as an association response signal. Through the processing of Step S805 and Step S806, association is established. When the association is established, an association identification (AID) for identifying the association is assigned. In the association response frame, the AID is configured. Through the processing of Step S801 to Step S806, an SBP session is established between the SBP initiator and the SBP responder. In such a state, the sensing procedure is executed between the sensing initiator and the sensing responder (Step S807).

The wireless frames exchanged between the SBP initiator and the SBP responder in the processing of Step S801 to Step S806, such as the association request frame described above, are wireless frames for establishing an SBP session. Thus, the wireless frames exchanged between the SBP initiator and the SBP responder in the processing of Step S801 to Step S806 are referred to as the “first wireless frame(s) for establishing an SBP session”.

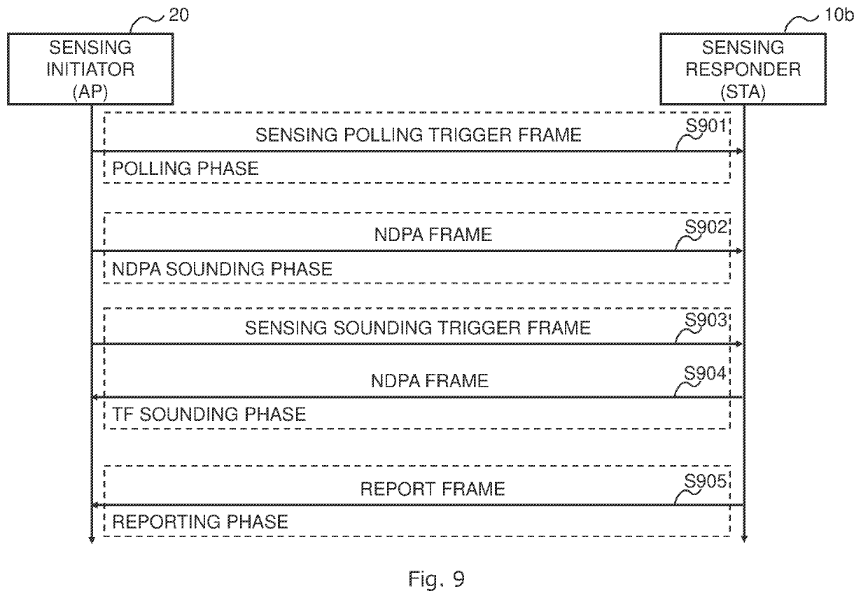

Next, with reference to FIG. 9, details of the sensing procedure will be described. In the sensing procedure employing the SBP procedure, the sensing procedure based on the TB sensing measurement instance is executed. In Step S901, the controller 210 in the sensing initiator generates a sensing polling trigger frame, and the transmitter 221 transmits the sensing polling trigger frame to the sensing responder. The sensing polling trigger frame is generated by configuring a value indicating the management frame to the type field described above, and configuring a value indicating the sensing polling trigger frame to the sub-type field. The sensing polling trigger frame may be referred to as a sensing polling trigger signal.

The sensing polling trigger frame is a wireless frame for making an inquiry to the STA 10, in other words, the sensing responder, as to whether the sensing responder can participate in the TB sensing measurement instance. The processing of Step S901 is referred to as a polling phase. The sensing responder that can participate in the TB sensing measurement instance responds to the sensing polling trigger frame, and thereby participates in the TB sensing measurement instance.

Next, the controller 210 in the sensing initiator generates a null data packet (NDP) announcement (NDPA) frame, and the transmitter 221 transmits the NDPA frame to the sensing responder (Step S902). The NDPA frame is generated by configuring a value indicating the management frame to the type field described above, and configuring a value indicating the NDPA frame to the sub-type field. The NDPA frame may be referred to as an NDPA signal. The NDPA frame may be referred to as a measurement frame or a measurement signal.

The NDPA frame is a wireless frame for causing the sensing responder to execute measurement. The processing of Step S902 is referred to as an NDPA sounding phase. When the sensing responder receives the NDPA frame, the sensing responder measures channel state information (CSI). In the NDPA sounding phase, the AP 20, in other words, the sensing initiator, is a sensing transmitter, and the STA 10b, in other words, the sensing responder, is a sensing receiver.

Next, the controller 210 in the sensing initiator generates a sensing sounding trigger frame, and the transmitter 221 transmits the sensing sounding trigger frame to the sensing responder (Step S903). The sensing sounding trigger frame is generated by configuring a value indicating the management frame to the type field described above, and configuring a value indicating the sensing sounding trigger frame to the sub-type field. The sensing sounding trigger frame may be referred to as a sensing sounding trigger signal.

Next, the controller 110 in the sensing responder generates an NDPA frame, and the transmitter 121 transmits the NDPA frame to the sensing initiator (Step S904). The NDPA frame is generated by configuring a value indicating the management frame to the type field described above, and configuring a value indicating the NDPA frame to the sub-type field.

The sensing sounding trigger frame is a wireless frame for the sensing initiator to request the sensing responder to transmit the NDPA frame. The processing of Step S903 and Step S904 is processing for the sensing initiator to execute measurement, and is referred to as a trigger frame (TF) sounding phase (TF sounding phase). When the sensing responder receives the sensing sounding trigger frame, the sensing responder transmits the NDPA frame to the sensing initiator. When the sensing initiator receives the NDPA frame, the sensing initiator measures CSI. In the TF sounding phase, the STA 10b, in other words, the sensing responder, is a sensing transmitter, and the AP 20, in other words, the sensing initiator, is a sensing receiver.

Next, the controller 110 in the sensing responder generates a report frame, and the transmitter 121 transmits the report frame to the sensing initiator (Step S905). The report frame is generated by configuring a value indicating the management frame to the type field described above, and configuring a value indicating the report frame to the sub-type field. The report frame includes measurement report information indicating measurement results of the CSI.

The processing of Step S905 is processing for the sensing responder to report results of CSI measurement, and is referred to as a reporting phase. When the sensing responder measures the CSI, the sensing responder transmits the report frame to the sensing initiator. In the, the AP 20, in other words, the sensing initiator, is a sensing transmitter, and the STA 10b, in other words, the sensing responder, is a sensing receiver.

In the sensing procedure based on the TB sensing measurement instance, the processing illustrated in FIG. 9 is merely an example, and one of the NDPA sounding phase and the TF sounding phase may not be executed. For example, when the TF sounding phase is not executed, only the STA 10b, in other words, the sensing responder, measures the CSI. For example, in the sensing procedure based on the TB sensing measurement instance, the phases illustrated in Table 1 may be executed in the order illustrated in Table 1.

TABLE 1
Example of Sensing Procedure based
on TB Sensing Measurement Instance

| | |
|---|---|
| Example 1 | 1) Polling Phase |
| | 2) NDPA Sounding Phase |
| | 3) Reporting Phase |
| Example 2 | 1) Polling Phase |
| | 2) TF Sounding Phase |
| | 3) Reporting Phase |
| Example 3 | 1) Polling Phase |
| | 2) NDPA Sounding Phase |
| | 3) TF Sounding Phase |
| | 4) Reporting Phase |
| Example 4 | 1) Polling Phase |
| | 2) TF Sounding Phase |
| | 3) NDPA Sounding Phase |
| | 4) Reporting Phase |
| Example 5 | 1) Polling Phase |
| | 2) NDPA Sounding Phase |
| | 3) TF Sounding Phase |
| | 4) Polling Phase |
| | 5) Reporting Phase |

In the sensing procedure described above, a measurement setup ID for identifying a measurement setup depending on a different operation attribute and a measurement instance ID for identifying a measurement instance are assigned.

Referring back to the description of FIG. 8, when the sensing procedure is executed, the controller 210 in the SBP responder generates an SBP report frame, and the transmitter 221 transmits the SBP report frame to the SBP initiator (Step S808). The SBP report frame is generated by configuring a value indicating the management frame to the type field described above, and configuring a value indicating the SBP report frame to the sub-type field. The SBP report frame includes measurement report information indicating measurement results of the CSI. The measurement report information includes the measurement results from the sensing responder, and when the TF sounding phase is executed, includes the measurement results from the sensing initiator. The SBP report frame may be referred to as an SBP report signal.

When the processing of Step S801 is initiated, both of the SBP initiator and the SBP responder initiate measurement of a timer. When the processing of Step S808 does not end before the timer expires, in other words, the SBP initiator does not receive the SBP report frame, the SBP procedure fails.

### 3. First Embodiment

Next, a first embodiment will be described. As described above, if an SBP session is disconnected after the SBP session is established and before the SBP initiator receives the SBP report frame, the SBP initiator cannot receive the SBP report frame. In the current IEEE 802.11bf, there is no definition as to resumption of the SBP procedure after the SBP session is disconnected.

In the present embodiment, if an SBP session is disconnected after the SBP session is established, the SBP initiator and the SBP responder reestablish or restore the SBP session by exchanging the second wireless frame for establishing the SBP session. To reestablish a session and to restore a session may be hereinafter interchangeably used.

Although the SBP procedure has been described with reference to FIG. 8, in the present embodiment, every time the SBP initiator and the SBP responder execute each processing in FIG. 8, the SBP initiator and the SBP responder both store information indicating that the SBP initiator and the SBP responder have executed the processing as historical information. For example, when the SBP initiator receives the association response frame from the SBP responder, the controller 110 stores an indication and/or an AID indicating that the association has been established in the memory 102 or a storage apparatus (not illustrated) as the historical information. Similarly, when the SBP responder receives the SBP request frame from the SBP initiator, the controller 210 stores an indication indicating that the SBP request frame has been received in the memory 202 or a storage apparatus (not illustrated) as the historical information.

As described above, in execution of the sensing procedure, the measurement setup ID and the measurement instance ID described above are assigned. In the present embodiment, the SBP initiator and the SBP responder both store the measurement setup ID and the measurement instance ID as the historical information. Although the measurement setup ID and the measurement instance ID are assigned to the sensing initiator, in the present embodiment, the AP 20 has a role of the SBP responder as well as the sensing initiator. Thus, when the measurement setup ID and the measurement instance ID are assigned, the SBP responder may notify the SBP initiator of those IDs.

In the present embodiment, every time the sensing initiator and the sensing responder execute each processing in FIG. 9, the sensing initiator and the sensing responder both store information indicating that the sensing initiator and the sensing responder have executed the processing as historical information. For example, when the sensing initiator receives the report frame from the sensing responder, the controller 210 stores an indication indicating that the report frame has been received and/or the measurement report information included in the report frame in the memory 202 or a storage apparatus (not illustrated) as the historical information. Similarly, when the sensing responder receives the sensing sounding trigger frame from the sensing initiator, the controller 110 stores an indication indicating that the sensing sounding trigger frame has been received in the memory 102 or a storage apparatus (not illustrated) as the historical information.

### 3.1. SBP Initiator Trigger Based Procedure

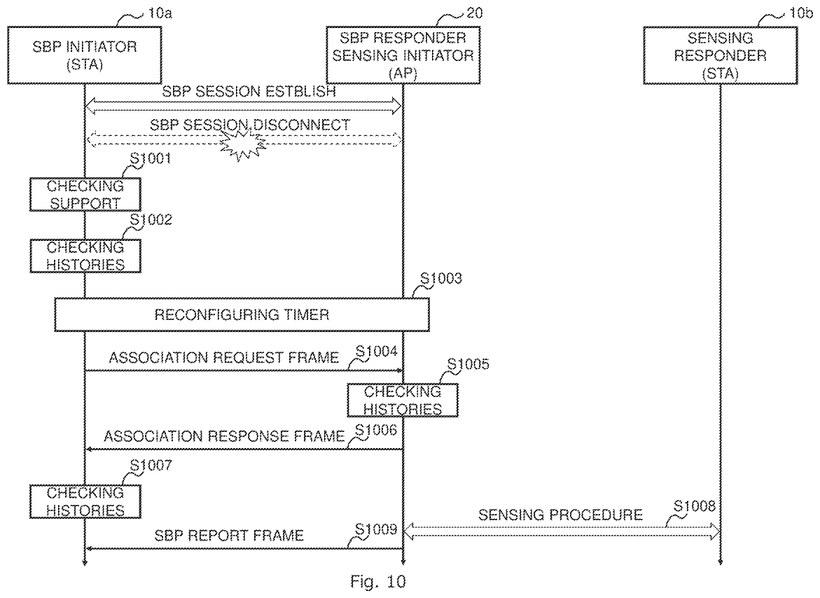

With reference to FIG. 10, description will be given regarding processing for reestablishing an SBP initiator trigger based SBP session if an SBP session is disconnected after the SBP session is established. In description of FIG. 10, after an SBP session is established, the SBP session is disconnected. In such a state, in response to a trigger from the SBP initiator, the SBP initiator and the SBP responder reestablish the SBP session.

For example, disconnection of the SBP session includes a case in which a session is disconnected because either the SBP initiator or the SBP responder fails to detect a beacon signal on a physical layer. Because the above-described timer functions on a MAC layer, in such a case, the SBP initiator may recognize disconnection of the session without expiration of the timer. For example, disconnection of the SBP session includes a case in which a session is disconnected because the timer expires with either the SBP initiator or the SBP responder failing to receive a wireless frame. Furthermore, for example, disconnection of the SBP session includes a case in which a session is disconnected with either the SBP initiator or the SBP responder transmitting a termination frame, a deauthentication frame, and a disassociation frame. A node that has received any of the termination frame, the deauthentication frame, and the disassociation frame disconnects or releases the SBP session.

In any of the cases described above, the SBP initiator detects disconnection of the SBP session, and in response thereto, the processing illustrated in FIG. 10 is initiated. In description of FIG. 10, a case is assumed that the STA 10a described with reference to FIG. 1 has a role of the SBP initiator. The AP 20 described with reference to FIG. 1 has roles of the SBP responder and the sensing initiator. Furthermore, the STA 10b described with reference to FIG. 1 has a role of the sensing responder.

In Step S1001, the controller 110 in the SBP initiator checks whether or not the controller 110 supports SBP procedure resume processing in the present embodiment. Information indicating whether or not to support the SBP procedure resume processing is stored in a storage apparatus (not illustrated) of the SBP initiator. In the processing of Step S1001, when the SBP initiator determines not to support the SBP procedure resume processing, the SBP procedure is resumed by executing the processing illustrated in FIG. 8, in other words, the SBP procedure in prior art.

In Step S1001, whether or not to execute the processing for resuming the SBP procedure according to the present embodiment is determined based on the information indicating whether or not to support the SBP procedure resume processing. In other words, whether or not the SBP initiator and the SBP responder exchange the second wireless frame for establishing an SBP session is determined based on the information indicating whether or not to support the SBP procedure resume processing.

Next, the controller 110 checks presence or absence of a history of the SBP procedure, in other words, whether or not the first wireless frame has been exchanged with the SBP responder, based on the historical information (Step S1002). As described above, every time the SBP initiator executes each processing of the SBP procedure, the SBP initiator stores the historical information. In the processing of Step S1002, for example, when the historical information includes an indication indicating that an association has been established, this means that the SBP initiator has already executed the SBP procedure and the association has been established. In the processing of Step S1002, when it is determined that the SBP procedure has not been executed, the SBP procedure is resumed by executing the processing illustrated in FIG. 8, in other words, the SBP procedure in prior art.

In Step S1002, based on the historical information, whether or not to execute the processing for resuming the SBP procedure according to the present embodiment is determined. In other words, whether or not the SBP initiator and the SBP responder exchange the second wireless frame for establishing an SBP session is determined based on the historical information.

Next, the controller 110 reconfigures the timer (Step S1003). In the processing, for example, when the SBP initiator recognizes disconnection of the SBP session before expiration of the timer, the timer may be reconfigured through extension of expiration time. In this case, for example, when the expiration time of the timer is 30 seconds, the expiration time is reconfigured to 45 seconds. Instead, the timer may be reconfigured through configuration of a measurement value to an initial value. In other words, measurement of the timer may be started again.

In the processing of Step S1003, the timer is reconfigured not only in the SBP initiator but also in the SBP responder. For example, in response to the controller 110 reconfiguring the timer, the transmitter 121 may transmit a wireless frame for instructing reconfiguration of the timer, in other words, a timer reconfiguration frame, to the SBP responder. When the expiration time of the timer is extended in reconfiguration of the timer, in order to inform the SBP responder of the extended expiration time, a value of the expiration time may be configured for the timer reconfiguration frame. A subsequent association request frame may have a role of the timer reconfiguration frame described above.

In the processing of Step S1003, for example, when an event of disconnection of the SBP session occurs n times within a predetermined period, it may be considered that a communication environment is not satisfactory, and the value configured for the timer may be prolonged. For example, when the expiration time of the timer is 30 seconds and measurement of the timer is started again, the expiration time may be reconfigured to 45 seconds, and then measurement of the timer may be started. Note that a timing of executing the processing for reconfiguring the timer illustrated in FIG. 10 is merely an example. The timer may be reconfigured at any timing after the SBP session is disconnected and before the SBP session is reestablished.

Next, the controller 110 generates an association request frame, and the transmitter 121 transmits the association request frame to the SBP responder (Step S1004). The association request frame transmitted in this case includes a historical information element (IE). The historical IE is information indicating a history of execution of the SBP procedure, in other words, a history of exchange of the first wireless frame with the SBP responder, for resumption of the SBP procedure. Note that the historical IE may also be referred to as a resume IE, a reestablish IE, or a recovery IE.

The historical IE may include the AID stored as the historical information. With use of the AID as the historical IE, the SBP responder can be informed that the SBP session has been established with a target SBP initiator. Instead of or in addition to the AID, the historical IE may include a destination address and a transmission source address configured for the wireless frame when the SBP session is established. In other words, the historical IE may include the device ID of the SBP initiator and the device ID of the SBP responder when the SBP session is established. The device ID includes a MAC address. These device IDs are also stored as the historical information when the SBP procedure is executed. Furthermore, instead of or in addition to the AID, the historical IE may include the measurement setup ID and/or the measurement instance ID stored as the historical information. With use of the measurement setup ID and/or the measurement instance ID as the historical IE, the SBP responder can be informed that the SBP session has been established with a target SBP initiator.

The association request frame transmitted in Step S1004 is a wireless frame for requesting reassociation, and may thus be a wireless frame of a sub-type different from the association request frame described with reference to FIG. 8. In this case, in the sub-type field described above, for example, a value indicating a reassociation request frame may be configured.

Next, when the receiver 222 in the SBP responder receives the association request frame, the controller 210 checks the history of the SBP procedure, in other words, whether or not the SBP session has been established with a target SBP initiator, based on the historical IE included in the association request frame (Step S1005). As described above, the historical IE includes the AID of the SBP session that has already been established, and thus whether or not the SBP session has been established with a target SBP initiator can be checked based on the AID. The historical IE includes the destination address and the transmission source address when the SBP procedure is executed, and thus whether or not the SBP session has been established with a target SBP initiator can be checked based on those addresses. Furthermore, the historical IE includes the measurement setup ID and/or the measurement instance ID assigned when the sensing procedure is executed, and thus whether or not the SBP session has been established with a target SBP initiator can be checked based on the ID(s).

Next, the controller 210 in the SBP responder generates an association response frame, and the transmitter 221 transmits the association response frame to the SBP initiator (Step S1006). The association response frame transmitted in this case includes a historical IE. The historical IE is information indicating a history of execution of the SBP procedure, in other words, a history of exchange of the first wireless frame with the SBP initiator, for resumption of the SBP procedure. Note that the historical IE may also be referred to as a resume IE, a reestablish IE, or a recovery IE.

The historical IE may include the AID stored as the historical information. With use of the AID as the historical IE, the SBP initiator can be informed that the SBP session has been established with a target SBP responder. Instead of or in addition to the AID, the historical IE may include a destination address and a transmission source address configured for the wireless frame when the SBP session is established. In other words, the historical IE may include the device ID of the SBP initiator and the device ID of the SBP responder when the SBP session is established. The device ID includes a MAC address. These device IDs are also stored as the historical information when the SBP procedure is executed. Furthermore, instead of or in addition to the AID, the historical IE may include the measurement setup ID and/or the measurement instance ID stored as the historical information. With use of the measurement setup ID and/or the measurement instance ID as the historical IE, the SBP responder can be informed that the SBP session has been established with a target SBP initiator.

The association response frame transmitted in Step S1006 is a wireless frame for responding to the reassociation request, and may thus be a wireless frame of a sub-type different from the association response frame described with reference to FIG. 8. In this case, in the sub-type field described above, for example, a value indicating a reassociation response frame may be configured.

Next, when the receiver 122 in the SBP initiator receives the association response frame, the controller 110 checks the history of the SBP procedure, in other words, whether or not the SBP session has been established with a target SBP responder, based on the historical IE included in the association response frame (Step S1007). As described above, the historical IE includes the AID of the SBP session that has already been established, and thus whether or not the SBP session has been established with a target SBP responder can be checked based on the AID. The historical IE includes the destination address and the transmission source address when the SBP procedure is executed, and thus whether or not the SBP session has been established with a target SBP responder can be checked based on those addresses. Furthermore, the historical IE includes the measurement setup ID and/or the measurement instance ID assigned when the sensing procedure is executed, and thus whether or not the SBP session has been established with a target SBP responder can be checked based on the ID(s).

Through the processing of Step S1001 to Step S1007, an SBP session is reestablished. The association request frame and the association response frame described above, in other words, the wireless frames exchanged between the SBP initiator and the SBP responder in the processing of Step S1004 and Step S1006, are wireless frames for establishing an SBP session. Thus, the wireless frames exchanged between the SBP initiator and the SBP responder in the processing of Step S1004 and Step S1006 are referred to as the “second wireless frame(s) for establishing an SBP session”.

Subsequently, the sensing procedure described with reference to FIG. 9 is executed between the sensing initiator and the sensing responder (Step S1008). In the sensing procedure, although the polling phase and the like described above are executed, based on the historical information, already executed phase(s) may be omitted and the sensing procedure may be resumed from a phase that has not been executed yet.

Based on the assumption that the sensing procedure is executed in the order illustrated in FIG. 9, for example, when the NDPA sounding phase has already been executed, the sensing initiator may resume the sensing procedure from the TF sounding phase. The sensing initiator may instruct the sensing responder to resume the sensing procedure from the TF sounding phase. For example, when the historical information stored in the sensing initiator includes an indication that the sensing initiator has transmitted the NDPA frame to the sensing responder, this means that the NDPA sounding phase has already been executed.

When the sensing procedure has already been executed and the sensing initiator receives the report frame from the sensing responder, the sensing procedure may be omitted in Step S1008. In this case, the controller 210 in the sensing initiator stores the measurement report information included in the report frame received from the sensing responder as the historical information.

In other words, the controller 210 in the sensing initiator generates a wireless frame for instructing resumption of the sensing procedure from processing that has not been executed yet based on the historical information, and the transmitter 221 transmits the wireless frame to the sensing responder.

Next, the controller 210 in the SBP responder generates an SBP report frame, and the transmitter 221 transmits the SBP report frame to the SBP initiator (Step S1009). Through the processing, the SBP procedure after resumption ends.

Through the processing illustrated in FIG. 10, the disconnected SBP session can be reestablished. With use of the historical IE such as the AID, both of the SBP initiator and the SBP responder can check a counterpart node when the SBP session is established, and as a result, the authentication processing can be omitted.

### 3.2. SBP Responder Trigger Based Procedure

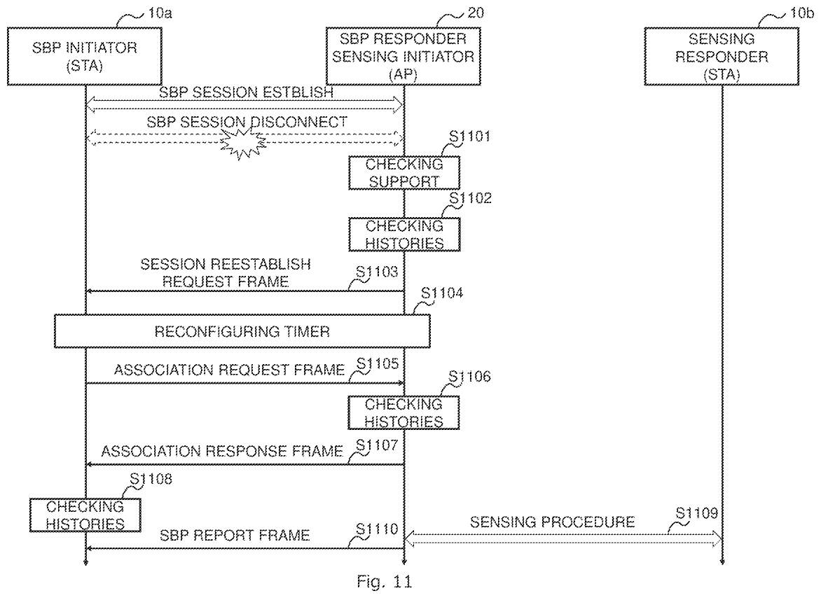

With reference to FIG. 11, description will be given regarding processing for reestablishing an SBP responder trigger based SBP session if an SBP session is disconnected after the SBP session is established. In description of FIG. 11, a case is assumed that after an SBP session is established, the SBP session is disconnected. In such a state, in response to a trigger from the SBP responder, the SBP initiator and the SBP responder reestablish the SBP session.

In the SBP responder trigger based procedure, the SBP responder detects disconnection of the SBP session, and in response thereto, the processing illustrated in FIG. 11 is initiated. In description of FIG. 11 as well, the STA 10a described with reference to FIG. 1 has a role of the SBP initiator. The AP 20 described with reference to FIG. 1 has roles of the SBP responder and the sensing initiator. Furthermore, the STA 10b described with reference to FIG. 1 has a role of the sensing responder.

Although the processing of Step S1101 and Step S1102 are similar to the processing of Step S1001 and Step S1002 illustrated in FIG. 10, an entity that executes the processing is the AP 20, in other words, the SBP responder.

Next, the controller 210 in the SBP responder generates a wireless frame for requesting reestablishment of a session, in other words, a session reestablish request frame, and the transmitter 221 transmits the session reestablish request frame to the SBP initiator (Step S1103). The session reestablish request frame is generated by configuring a value indicating the management frame to the type field described above, and configuring a value indicating the session reestablish request frame to the sub-type field. The session reestablish request frame may be referred to as a session reestablish request signal. The processing of Step S1103 is processing for the SBP responder to request the SBP initiator to reestablish an SBP session.

Next, the controller 210 reconfigures the timer (Step S1104). The processing is similar to the processing of Step S1003 illustrated in FIG. 10. The controller 110 in the SBP initiator also reconfigures the timer. For example, the controller 110 may reconfigure the timer, in response to reception of the session reestablish request frame. In this case, the session reestablish request frame has a role of the timer reconfiguration frame described above.

Subsequently, processing of Step S1105 to Step S1110 is executed. The processing of these steps is similar to the processing of Step S1004 to Step S1009 illustrated in FIG. 10, and thus detailed description thereof will be omitted.

Through the processing of Step S1101 to Step S1108, an SBP session is reestablished. The wireless frames exchanged between the SBP initiator and the SBP responder in the processing of Step S1103, Step S1105, and Step S1107, such as the session reestablish request frame described above, are wireless frames for establishing an SBP session. Thus, these wireless frames are also referred to as the “second wireless frame(s) for establishing an SBP session”.

As described above, the processing according to the first embodiment has been described. According to the present embodiment, if the SBP session established between the SBP initiator and the SBP responder is disconnected, the SBP procedure can be resumed by reestablishing the SBP session.

The order of the processing illustrated in FIG. 10 and FIG. 11 is merely an example, and the order may be partially changed. Not necessarily all of the processing illustrated in FIG. 10 and FIG. 11 is required, and the processing may be partially omitted. Furthermore, processing not illustrated in FIG. 10 and FIG. 11 may be executed, and for example, authentication may be executed before transmission of the association request frame. In other words, the authentication frame may be exchanged between the SBP initiator and the SBP responder before execution of the processing of Step S1004.

### 4. Second Embodiment

Next, a second embodiment will be described. In the first embodiment, association processing is executed in order to resume an SBP session, whereas in the second embodiment, the association processing is omitted.

### 4.1. SBP Initiator Trigger Based Procedure

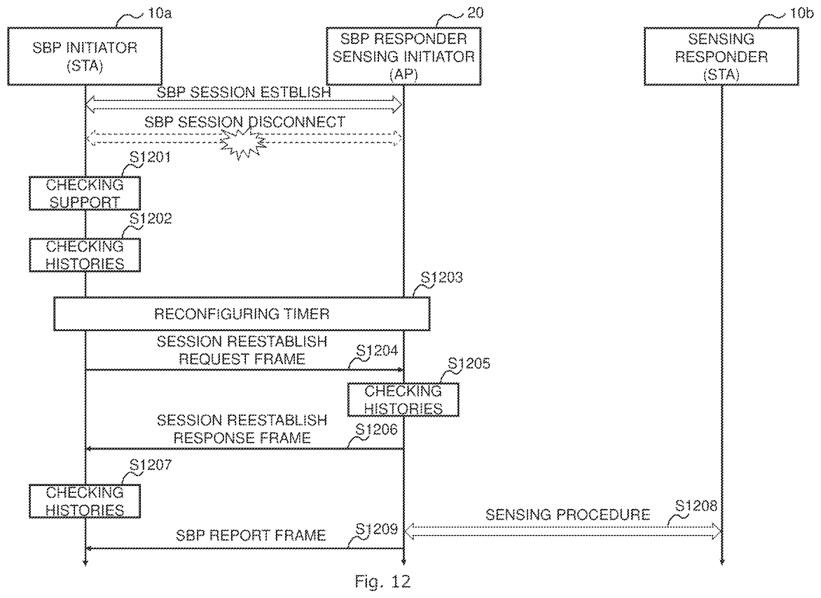

With reference to FIG. 12, description will be given regarding processing for reestablishing an SBP initiator trigger based SBP session if an SBP session is disconnected after the SBP session is established. In description of FIG. 12 as well, the STA 10a described with reference to FIG. 1 has a role of the SBP initiator. The AP 20 described with reference to FIG. 1 has roles of the SBP responder and the sensing initiator. Furthermore, the STA 10b described with reference to FIG. 1 has a role of the sensing responder.

Of the processing illustrated in FIG. 12, Step S1201 to Step S1203 and Step S1208 to Step S1209 are similar to Step S1001 to Step S1003 and Step S1008 to Step S1009 in FIG. 10, and thus detailed description thereof will be omitted.

In Step S1204, the controller 110 in the SBP initiator generates a wireless frame for requesting reestablishment of a session, in other words, a session reestablish request frame, and the transmitter 121 transmits the session reestablish request frame to the SBP responder. The session reestablish request frame is generated by configuring a value indicating the management frame to the type field described above, and configuring a value indicating the session reestablish request frame to the sub-type field. The session reestablish request frame may be referred to as a session reestablish request signal. The session reestablish request frame includes a historical IE. The historical IE is information indicating a history of execution of the SBP procedure, in other words, a history of exchange of the first wireless frame with the SBP responder, for resumption of the SBP procedure.

The historical IE may include the AID stored as the historical information. With use of the AID as the historical IE, the SBP responder can be informed that the SBP session has been established with a target SBP initiator. Instead of or in addition to the AID, the historical IE may include a destination address and a transmission source address configured for the wireless frame when the SBP session is established. In other words, the historical IE may include the device ID of the SBP initiator and the device ID of the SBP responder when the SBP session is established. The device ID includes a MAC address. These device IDs are also stored as the historical information when the SBP procedure is executed. Furthermore, instead of or in addition to the AID, the historical IE may include the measurement setup ID and/or the measurement instance ID stored as the historical information. With use of the measurement setup ID and/or the measurement instance ID as the historical IE, the SBP responder can be informed that the SBP session has been established with a target SBP initiator.

Next, when the receiver 222 in the SBP responder receives the session reestablish request frame, the controller 210 checks the history of the SBP procedure, in other words, whether or not the SBP session has been established with a target SBP initiator, based on the historical IE included in the session reestablish request frame (Step S1205). As described above, the historical IE includes the AID of the SBP session that has already been established, and thus whether or not the SBP session has been established with a target SBP initiator can be checked based on the AID. The historical IE includes the destination address and the transmission source address when the SBP procedure is executed, and thus whether or not the SBP session has been established with a target SBP initiator can be checked based on those addresses. Furthermore, the historical IE includes the measurement setup ID and/or the measurement instance ID assigned when the sensing procedure is executed, and thus whether or not the SBP session has been established with a target SBP initiator can be checked based on the ID(s).

Next, the controller 210 in the SBP responder generates a wireless frame for responding to the session reestablish request, in other words, a session reestablish response frame, and the transmitter 221 transmits the session reestablish response frame to the SBP initiator (Step S1206). The session reestablish response frame transmitted in this case includes a historical IE. The historical IE is information indicating a history of execution of the SBP procedure, in other words, a history of exchange of the first wireless frame with the SBP initiator, for resumption of the SBP procedure.

The historical IE may include the AID stored as the historical information. With use of the AID as the historical IE, the SBP initiator can be informed that the SBP session has been established with a target SBP responder. Instead of or in addition to the AID, the historical IE may include a destination address and a transmission source address configured for the wireless frame when the SBP session is established. In other words, the historical IE may include the device ID of the SBP initiator and the device ID of the SBP responder when the SBP session is established. The device ID includes a MAC address. These device IDs are also stored as the historical information when the SBP procedure is executed. Furthermore, instead of or in addition to the AID, the historical IE may include the measurement setup ID and/or the measurement instance ID stored as the historical information. With use of the measurement setup ID and/or the measurement instance ID as the historical IE, the SBP initiator can be informed that the SBP session has been established with a target SBP responder.

Next, when the receiver 122 in the SBP initiator receives the session reestablish response frame, the controller 110 checks the history of the SBP procedure, in other words, whether or not the SBP session has been established with a target SBP responder, based on the historical IE included in the session reestablish response frame (Step S1207). As described above, the historical IE includes the AID of the SBP session that has already been established, and thus whether or not the SBP session has been established with a target SBP responder can be checked based on the AID. The historical IE includes the destination address and the transmission source address when the SBP procedure is executed, and thus whether or not the SBP session has been established with a target SBP responder can be checked based on those addresses.

Through the processing of Step S1201 to Step S1207, the disconnected SBP session can be reestablished. With use of the historical IE such as the AID, both of the SBP initiator and the SBP responder can check a counterpart node when the SBP session is established, and as a result, the association processing can be omitted.

The session reestablish request frame and the session reestablish response frame described above, in other words, the wireless frames exchanged between the SBP initiator and the SBP responder in the processing of Step S1204 and Step S1206, are wireless frames for establishing an SBP session. Thus, the wireless frames exchanged between the SBP initiator and the SBP responder in the processing of Step S1204 and Step S1206 are also referred to as the “second wireless frame(s) for establishing an SBP session”.

### 4.2. SBP Responder Trigger Based Procedure

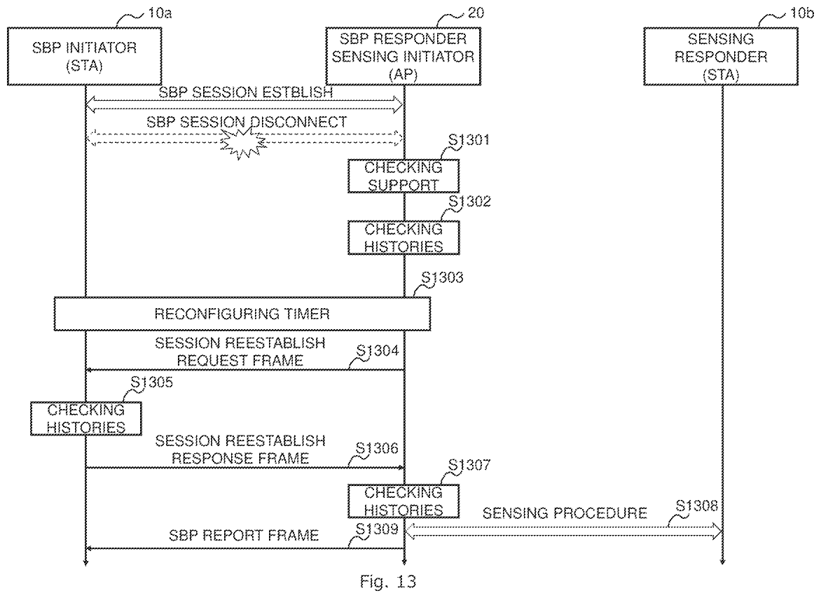

With reference to FIG. 13, description will be given regarding processing for reestablishing an SBP responder trigger based SBP session if an SBP session is disconnected after the SBP session is established. In description of FIG. 13, a case is assumed that after an SBP session is established, the SBP session is disconnected. In such a state, in response to a trigger from the SBP responder, the SBP initiator and the SBP responder reestablish the SBP session.

In the SBP responder trigger based procedure, the SBP responder detects disconnection of the SBP session, and in response thereto, the processing illustrated in FIG. 13 is initiated. In description of FIG. 13 as well, the STA 10a described with reference to FIG. 1 has a role of the SBP initiator. The AP 20 described with reference to FIG. 1 has roles of the SBP responder and the sensing initiator. Furthermore, the STA 10b described with reference to FIG. 1 has a role of the sensing responder.

Of the processing illustrated in FIG. 13, Step S1301 to Step S1303 and Step S1308 to Step S1309 are similar to Step S1101, Step S1102, Step S1104, and Step S1108 to Step S1109 in FIG. 11, and thus detailed description thereof will be omitted.

In Step S1304, the controller 210 in the SBP responder generates a session reestablish request frame, and the transmitter 221 transmits the session reestablish request frame to the SBP initiator. The session reestablish request frame is similar to the session reestablish request frame described with reference to FIG. 12, and includes a historical IE indicating similar information.

Next, when the receiver 122 in the SBP initiator receives the session reestablish request frame, the controller 110 checks the history of the SBP procedure, in other words, whether or not the SBP session has been established with a target SBP responder, based on the historical IE included in the session reestablish request frame (Step S1305).

Next, the controller 110 in the SBP initiator generates a session reestablish response frame, and the transmitter 121 transmits the session reestablish response frame to the SBP responder (Step S1306). The session reestablish response frame is similar to the session reestablish response frame described with reference to FIG. 12, and includes a historical IE indicating similar information.

Next, when the receiver 222 in the SBP responder receives the session reestablish response frame, the controller 210 checks the history of the SBP procedure, in other words, whether or not the SBP session has been established with a target SBP initiator, based on the historical IE included in the session reestablish response frame (Step S1307).

Through the processing of Step S1301 to Step S1307, the disconnected SBP session can be reestablished. With use of the historical IE such as the AID, both of the SBP initiator and the SBP responder can check a counterpart node when the SBP session is established, and as a result, the association processing can be omitted.

The session reestablish request frame and the session reestablish response frame described above, in other words, the wireless frames exchanged between the SBP initiator and the SBP responder in the processing of Step S1304 and Step S1306, are wireless frames for establishing an SBP session. Thus, the wireless frames exchanged between the SBP initiator and the SBP responder in the processing of Step S1304 and Step S1306 are also referred to as the “second wireless frame(s) for establishing an SBP session”.

As described above, the processing according to the second embodiment has been described. According to the present embodiment, if the SBP session established between the SBP initiator and the SBP responder is disconnected, the SBP procedure can be resumed by reestablishing the SBP session without executing the association processing.

The order of the processing illustrated in FIG. 12 and FIG. 13 is merely an example, and the order may be partially changed. Not necessarily all of the processing illustrated in FIG. 12 and FIG. 13 is required, and the processing may be partially omitted. Furthermore, processing not illustrated in FIG. 12 and FIG. 13 may be executed, and for example, authentication may be executed after transmission of the session reestablish response frame. In other words, the authentication frame may be exchanged between the SBP initiator and the SBP responder after execution of the processing of Step S1307.

### 5. Other Embodiments

In order to resume the SBP procedure after an SBP session is disconnected, the SBP initiator and the SBP responder may resume the SBP procedure by executing the processing illustrated in FIG. 8, in other words, the SBP procedure in prior art. In this case, after the SBP session is disconnected, the wireless frames exchanged between the SBP initiator and the SBP responder in the processing of Step S801 to Step S806 in FIG. 8 are exchanged again between the SBP initiator and the SBP responder.

As described above, the wireless frames exchanged between the SBP initiator and the SBP responder in the processing of Step S801 to Step S806 in order to first establish an SBP session are referred to as the “first wireless frame(s) for establishing an SBP session”. In contrast, the wireless frames exchanged between the SBP initiator and the SBP responder in the processing of Step S801 to Step S806 in order to reestablish an SBP session after the SBP session is disconnected are referred to as the “second wireless frame(s) for establishing an SBP session”.

Expressions such as words and phrases used in the embodiments are merely examples, and may be replaced with substantially the same or similar expressions. Particularly, since the technique according to the embodiments relates to technical specifications, the expressions in the embodiments may be replaced with substantially the same or similar expressions in the technical specifications (for example, the technical specifications cited in the Specification of the present application). The information transmitted and received in the embodiments may be exchanged in the same or a different message or the same or a different element as or from that already described in the technical specifications, or may be exchanged in a new message or element to be defined. The information exchanged in the embodiments may be exchanged using a different layer and/or a different channel from that of the embodiments.

The means and/or the functions provided by the apparatuses described in the embodiments can be provided by software stored in a tangible memory apparatus and a computer that executes the software, the software only, hardware only, or a combination of those. For example, when one of the apparatuses is provided by an electronic circuit being hardware, it can be provided by a digital circuit including a number of logic circuits or an analog circuit.

The apparatuses described in the embodiments execute a program stored in a non-transitory tangible storage medium. Execution of the program causes execution of a method corresponding to the program.

### 6. Supplementary Notes

The whole or part of the embodiments and the alterations can be described as the following supplementary notes, but the disclosure is not limited to the contents of the following supplementary notes. The following expresses relationships in which a supplementary note that depends upon a plurality of supplementary notes depends upon a supplementary note that depends upon a plurality of supplementary notes. All of the dependency relationships of the supplementary notes expressed below are included in the embodiments.

### Supplementary Note 1

A sensing by proxy (SBP) initiator comprising:
a memory storing instructions; and
one or more processors configured to execute the instructions to:
   establish an SBP session by exchanging, with an SBP responder, a first wireless frame for establishing the SBP session; and
   in a case where the SBP session is disconnected, reestablish the SBP session by exchanging, with the SBP responder, a second wireless frame for establishing the SBP session.

### Supplementary Note 2

The SBP initiator according to supplementary note 1, wherein the second wireless frame includes information indicating that the first wireless frame has been exchanged with the SBP responder.

### Supplementary Note 3

The SBP initiator according to supplementary note 2, wherein the information includes an association identification (AID) assigned in a case where the SBP session is established by exchanging the first wireless frame.

### Supplementary Note 4

The SBP initiator according to supplementary note 2 or 3, wherein
the information includes a device identification (ID) of a transmission destination node and a device ID of a transmission source node configured for the first wireless frame.

### Supplementary Note 5

The SBP initiator according to supplementary note 4, wherein
the device ID includes a media access control (MAC) address.

### Supplementary Note 6

The SBP initiator according to any one of supplementary notes 2 to 5, wherein
the SBP responder executes as a sensing initiator a sensing procedure with a sensing responder, and
the information includes a measurement setup ID assigned in a case where the sensing procedure is executed.

### Supplementary Note 7

The SBP initiator according to any one of supplementary notes 2 to 6, wherein
the SBP responder executes as a sensing initiator a sensing procedure with a sensing responder, and
the information includes a measurement instance ID assigned in a case where the sensing procedure is executed.

### Supplementary Note 8

The SBP initiator according to any one of supplementary notes 2 to 7, wherein
the one or more processors are further configured to execute the instructions to check that the SBP session has been established with the SBP responder, based on the information included in the second wireless frame received from the SBP responder.

### Supplementary Note 9

The SBP initiator according to any one of supplementary notes 1 to 8, wherein
the one or more processors are further configured to execute the instructions to exchange the second wireless frame by
   transmitting a wireless frame for requesting association to the SBP responder, and
   receiving a wireless frame for responding to the request from the SBP responder.

### Supplementary Note 10

The SBP initiator according to any one of supplementary notes 1 to 8, wherein
the one or more processors are further configured to execute the instructions to exchange the second wireless frame by
   receiving a wireless frame for requesting reestablishment of the SBP session from the SBP responder,
   transmitting a wireless frame for requesting association to the SBP responder, and
   receiving a wireless frame for responding to the request from the SBP responder.

### Supplementary Note 11

The SBP initiator according to any one of supplementary notes 1 to 8, wherein
the one or more processors are further configured to execute the instructions to exchange the second wireless frame by
   transmitting a wireless frame for requesting reestablishment of the SBP session to the SBP responder, and
   receiving a wireless frame for responding to the request from the SBP responder.

### Supplementary Note 12

The SBP initiator according to any one of supplementary notes 1 to 8, wherein
the one or more processors are further configured to execute the instructions to exchange the second wireless frame by
   receiving a wireless frame for requesting reestablishment of the SBP session from the SBP responder, and
   transmitting a wireless frame for responding to the request to the SBP responder.

### Supplementary Note 13

The SBP initiator according to any one of supplementary notes 1 to 12, wherein
the one or more processors are further configured to execute the instructions to
   measure a timer, and
   after the SBP session is disconnected, reconfigure the timer.

### Supplementary Note 14

The SBP initiator according to supplementary note 13, wherein
the one or more processors are further configured to execute the instructions to reconfigure the timer by extending expiration time of the timer.

### Supplementary Note 15

The SBP initiator according to supplementary note 13, wherein
the one or more processors are further configured to execute the instructions to reconfigure the timer by starting measurement of the timer again.

### Supplementary Note 16

The SBP initiator according to any one of supplementary notes 1 to 15, wherein
the one or more processors are further configured to execute the instructions to determine whether or not to exchange the second wireless frame, based on information indicating that the first wireless frame has been exchanged.

### Supplementary Note 17

The SBP initiator according to any one of supplementary notes 1 to 16, wherein
the one or more processors are further configured to execute the instructions to determine whether or not to exchange the second wireless frame, based on information indicating that the SBP initiator supports resumption of an SBP procedure.

### Supplementary Note 18

A sensing by proxy (SBP) responder comprising:
a memory storing instructions; and
one or more processors configured to execute the instructions to:
   establish an SBP session by exchanging, with an SBP initiator, a first wireless frame for establishing the SBP session; and
   in a case where the SBP session is disconnected, reestablish the SBP session by exchanging, with the SBP initiator, a second wireless frame for establishing the SBP session.

### Supplementary Note 19

The SBP responder according to supplementary note 18, wherein
the second wireless frame includes information indicating that the first wireless frame has been exchanged with the SBP initiator.

### Supplementary Note 20

The SBP responder according to supplementary note 19, wherein
the information includes an association identification (AID) assigned when the SBP session is established by exchanging the first wireless frame.

### Supplementary Note 21

The SBP responder according to supplementary note 19 or 29, wherein
the information includes a device identification (ID) of a transmission destination node and a device ID of a transmission source node configured for the first wireless frame.

### Supplementary Note 22

The SBP responder according to supplementary note 21, wherein
the device ID includes a media access control (MAC) address.

### Supplementary Note 23

The SBP responder according to any one of supplementary notes 19 to 22, wherein
the one or more processors are further configured to execute the instructions to execute as a sensing initiator a sensing procedure with a sensing responder, and
the information includes a measurement setup ID assigned when the sensing procedure is executed.

### Supplementary Note 24

The SBP responder according to any one of supplementary notes 19 to 23, wherein
the one or more processors are further configured to execute the instructions to execute as a sensing initiator a sensing procedure with a sensing responder, and
the information includes a measurement instance ID assigned when the sensing procedure is executed.

### Supplementary Note 25

The SBP responder according to any one of supplementary notes 19 to 24, wherein
the one or more processors are further configured to execute the instructions to check that the SBP session has been established with the SBP initiator, based on the information included in the second wireless frame received from the SBP initiator.

### Supplementary Note 26

The SBP responder according to any one of supplementary notes 18 to 25, wherein
the one or more processors are further configured to execute the instructions to exchange the second wireless frame by
   receiving a wireless frame for requesting association from the SBP initiator, and
   transmitting a wireless frame for responding to the request to the SBP initiator.

### Supplementary Note 27

The SBP responder according to any one of supplementary notes 18 to 25, wherein
the one or more processors are further configured to execute the instructions to exchange the second wireless frame by
   transmitting a wireless frame for requesting reestablishment of the SBP session to the SBP initiator,
   receiving a wireless frame for requesting association from the SBP initiator, and
   transmitting a wireless frame for responding to the request to the SBP initiator.

### Supplementary Note 28

The SBP responder according to any one of supplementary notes 18 to 25, wherein
the one or more processors are further configured to execute the instructions to exchange the second wireless frame by
   receiving a wireless frame for requesting reestablishment of the SBP session from the SBP initiator, and
   transmitting a wireless frame for responding to the request to the SBP initiator.

### Supplementary Note 29

The SBP responder according to any one of supplementary notes 18 to 25, wherein
the one or more processors are further configured to execute the instructions to exchange the second wireless frame by
   transmitting a wireless frame for requesting reestablishment of the SBP session to the SBP initiator, and
   receiving a wireless frame for responding to the request from the SBP initiator.

### Supplementary Note 30

The SBP responder according to any one of supplementary notes 18 to 29, wherein
the one or more processors are further configured to execute the instructions to
   measure a timer, and
   after the SBP session is disconnected, reconfigure the timer.

### Supplementary Note 31

The SBP responder according to supplementary note 30, wherein
the one or more processors are further configured to execute the instructions to reconfigure the timer by extending expiration time of the timer.

### Supplementary Note 32

The SBP responder according to supplementary note 20, wherein
the one or more processors are further configured to execute the instructions to reconfigure the timer by starting measurement of the timer again.

### Supplementary Note 33

The SBP responder according to any one of supplementary notes 18 to 32, wherein
the one or more processors are further configured to execute the instructions to determine whether or not to exchange the second wireless frame, based on information indicating that the first wireless frame has been exchanged.

### Supplementary Note 34

The SBP responder according to any one of supplementary notes 18 to 33, wherein
the one or more processors are further configured to execute the instructions to determine whether or not to exchange the second wireless frame, based on information indicating that the SBP initiator supports resumption of an SBP procedure.

### Supplementary Note 35

The SBP responder according to supplementary note 23 or 24, wherein
the one or more processors are further configured to execute, after the SBP session is disconnected, the instructions to transmit a wireless frame for instructing resumption of the sensing procedure from processing that has not been executed yet to the sensing responder, based on information indicating that the sensing procedure has been executed.

### Supplementary Note 36

A method executed by a sensing by proxy (SBP) initiator, the method comprising:

establishing an SBP session by exchanging, with an SBP responder, a first wireless frame for establishing the SBP session; and

in a case where the SBP session is disconnected, reestablishing the SBP session by exchanging, with the SBP responder, a second wireless frame for establishing the SBP session.

### Supplementary Note 37

A method executed by a sensing by proxy (SBP) responder, the method comprising:
establishing an SBP session by exchanging, with an SBP initiator, a first wireless frame for establishing the SBP session; and
in a case where the SBP session is disconnected, reestablishing the SBP session by exchanging, with the SBP initiator, a second wireless frame for establishing the SBP session.

### Supplementary Note 38

A program, when being executed, cause one or more processors in a sensing by proxy (SBP) initiator to execute:
establishing an SBP session by exchanging, with an SBP responder, a first wireless frame for establishing the SBP session; and
in a case where the SBP session is disconnected, reestablishing the SBP session by exchanging, with the SBP responder, a second wireless frame for establishing the SBP session.

### Supplementary Note 39

A program, when being executed, causing one or more processors in a sensing by proxy (SBP) responder to execute:
establishing an SBP session by exchanging, with an SBP initiator, a first wireless frame for establishing the SBP session; and
in a case where the SBP session is disconnected, reestablishing the SBP session by exchanging, with the SBP initiator, a second wireless frame for establishing the SBP session.

### Supplementary Note 40

A computer-readable non-transitory tangible storage medium storing a program, when being executed, causing one or more processors in a sensing by proxy (SBP) initiator to execute:
establishing an SBP session by exchanging, with an SBP responder, a first wireless frame for establishing the SBP session; and
in a case where the SBP session is disconnected, reestablishing the SBP session by exchanging, with the SBP responder, a second wireless frame for establishing the SBP session.

### Supplementary Note 41

A computer-readable non-transitory tangible storage medium storing a program, when being executed, causing one or more processors in a sensing by proxy (SBP) responder to execute:
establishing an SBP session by exchanging, with an SBP initiator, a first wireless frame for establishing the SBP session; and
in a case where the SBP session is disconnected, reestablishing the SBP session by exchanging, with the SBP initiator, a second wireless frame for establishing the SBP session.

What is claimed is:

1. A sensing by proxy (SBP) initiator comprising:
a memory storing instructions; and
one or more processors configured to execute the instructions to:
establish an SBP session by exchanging, with an SBP responder, a first wireless frame for establishing the SBP session; and
in a case where the SBP session is disconnected, reestablish the SBP session by exchanging, with the SBP responder, a second wireless frame for establishing the SBP session.

2. The SBP initiator according to claim 1, wherein
the second wireless frame includes information indicating that the first wireless frame has been exchanged with the SBP responder.

3. The SBP initiator according to claim 2, wherein
the information includes an association identification (AID) assigned in a case where the SBP session is established by exchanging the first wireless frame.

4. The SBP initiator according to claim 2, wherein
the information includes a device identification (ID) of a transmission destination node and a device ID of a transmission source node configured for the first wireless frame.

5. The SBP initiator according to claim 4, wherein
the device ID includes a media access control (MAC) address.

6. The SBP initiator according to claim 2, wherein
the SBP responder executes as a sensing initiator a sensing procedure with a sensing responder and
the information includes a measurement setup ID assigned in a case where the sensing procedure is executed.

7. The SBP initiator according to claim 2, wherein
the SBP responder executes as a sensing initiator a sensing procedure with a sensing responder, and
the information includes a measurement instance ID assigned in a case where the sensing procedure is executed.

8. The SBP initiator according to claim 2, wherein
the one or more processors are further configured to execute the instructions to check that the SBP session has been established with the SBP responder, based on the information included in the second wireless frame received from the SBP responder.

9. The SBP initiator according to claim 1, wherein
the one or more processors are further configured to execute the instructions to exchange the second wireless frame by
transmitting a wireless frame for requesting association to the SBP responder, and
receiving a wireless frame for responding to the request from the SBP responder.

10. The SBP initiator according to claim 1, wherein
the one or more processors are further configured to execute the instructions to exchange the second wireless frame by
receiving a wireless frame for requesting reestablishment of the SBP session from the SBP responder,
transmitting a wireless frame for requesting association to the SBP responder, and
receiving a wireless frame for responding to the request from the SBP responder.

11. The SBP initiator according to claim 1, wherein
the one or more processors are further configured to execute the instructions to exchange the second wireless frame by
transmitting a wireless frame for requesting reestablishment of the SBP session to the SBP responder, and
receiving a wireless frame for responding to the request from the SBP responder.

12. The SBP initiator according to claim 1, wherein
the one or more processors are further configured to execute the instructions to exchange the second wireless frame by
receiving a wireless frame for requesting reestablishment of the SBP session from the SBP responder, and
transmitting a wireless frame for responding to the request to the SBP responder.

13. The SBP initiator according to claim 1, wherein
the one or more processors are further configured to execute the instructions to
measure a timer, and
after the SBP session is disconnected, reconfigure the timer.

14. The SBP initiator according to claim 13, wherein
the one or more processors are further configured to execute the instructions to reconfigure the timer by extending expiration time of the timer.

15. The SBP initiator according to claim 13, wherein
the one or more processors are further configured to execute the instructions to reconfigure the timer by starting measurement of the timer again.

16. The SBP initiator according to claim 1, wherein
the one or more processors are further configured to execute the instructions to determine whether or not to exchange the second wireless frame, based on information indicating that the first wireless frame has been exchanged.

17. The SBP initiator according to claim 1, wherein
the one or more processors are further configured to execute the instructions to determine whether or not to exchange the second wireless frame, based on information indicating that the SBP initiator supports resumption of an SBP procedure.

18. A sensing by proxy (SBP) responder comprising:
a memory storing instructions; and
one or more processors configured to execute the instructions to:
establish an SBP session by exchanging, with an SBP initiator, a first wireless frame for establishing the SBP session; and
in a case where the SBP session is disconnected, reestablish the SBP session by exchanging, with the SBP initiator, a second wireless frame for establishing the SBP session.

19. A method executed by a sensing by proxy (SBP) initiator, the method comprising:
establishing an SBP session by exchanging, with an SBP responder, a first wireless frame for establishing the SBP session; and
in a case where the SBP session is disconnected, reestablishing the SBP session by exchanging, with the SBP responder, a second wireless frame for establishing the SBP session.
